(19) United States
(12) Patent Application Publication
(10) Pub. No.: US 2008/0195548 A1
(43) Pub. Date: Aug. 14, 2008

(54) License Data Structure and License Issuing Method

(76) Inventors: Hyun Gon Chu, Busan (KR); Young Bae Byun, Seoul (KR); Bum Suk Choi, Daejeon (KR); Sang Hyun Ju, Daejeon (KR); Je Ho Nam, Daejeon (KR); Jin Woo Hong, Daejeon (KR)

Correspondence Address: LADAS & PARRY LLP, 224 SOUTH MICHIGAN AVENUE, SUITE 1600, CHICAGO, IL, 60604, US

(21) Appl. No.: 11/911,127

(22) PCT Filed: Apr. 11, 2006
(86) PCT No.: PCT/KR06/01327

§ 371 Date: Oct. 10, 2007

(30) Foreign Application Priority Data
Apr. 11, 2005 (KR) 10-2005-0030029

(51) Int. Cl. G06Q 10/00; H04L 9/00; G06F 19/00

(52) U.S. Cl. 705/59; 705/1; 380/277

(57) ABSTRACT

A license data structure and distribution (issuance) method are provided, that can accommodate one domain including multiple content playback devices and/or users. A method for creating license data in the invention includes the steps of: creating raw license data to be issued; firstly encrypting the raw license data with an encryption key of a user and/or device; and encrypting the data encrypted with the user and/or device public key using a public key of a home domain. Also, a license data structure of the invention includes an encrypted license block created by firstly encrypting raw license data containing data for playing content with a distributed encryption key of a user and/or device, and then secondly encrypting this with a distributed encryption key of a home domain; and TAG information necessary for decryption of a second encryption capsule.

### TECHNICAL FIELD

The present invention relates to a method of issuing a license in a user domain intended for application in a digital content protection/management system. Particularly, the present invention relates to a method of issuing a license in a single home domain comprised of a plurality of designated users and/or devices.

### BACKGROUND

Digital content has superior quality and is easy to manipulate compared to conventional analog content. However, because digital content can be repeatedly copied, the risk and potential range of copyright infringement are much greater. Especially in the case of digital broadcasting 1 5 which provides clear digital content to many subscribers, copyright infringement happens frequently. Thus, as the importance of digital content protection rapidly increases along with digital industry development, various methods for digital rights management (DRM) and systems for broadcast content management and protection (BCMP) employing the DRM methods have been developed.

To solve the above problem, in a conventional digital content protection/management system, all or parts of the content, necessary for playback, are encrypted and then transmitted. A digital content playback device which has received the coded content decrypts and plays the encrypted content using a license or a security key downloaded from an outside license-associated server, if necessary in advance.

Such a method for distributing contents and licenses has difficulty satisfying the practical needs of individual subscribers who possess more than one digital content device, and of families who want to enjoy digital content together at home. If a digital content is allowed to be actively shared between users, its security becomes seriously impaired making it easy to illegally copy. On the other hand, if the security of digital content is enforced, users are inconvenienced when it comes to sharing content between different authorized users and between devices. Thus there is a trade-off between security and convenience.

### [Disclosure]

### [Technical Problem]

The present invention is directed to a license data structure and issuing method which can accommodate a user possessing several content playback devices and/or a plurality of users being included in one home domain.

The present invention is also directed to a license data structure and issuing method which can enhance both user convenience and digital content security.

The present invention is also directed to a license data structure and issuing method conducive to a logical digital content market.

### [Technical Solution]

According to one aspect of the present invention, a method for creating license data includes the steps of: creating raw license data to be issued; firstly encrypting the raw license data with at least one of a user encryption key and a device encryption key; and secondly encrypting the firstly encrypted data with an encryption key of a domain.

According to another aspect of the present invention, a license data structure includes: an encrypted license block created by firstly encrypting raw license data containing data necessary for playing content with at least one of a user encryption key and a device encryption key, and secondly encrypting the data with a distributed encryption key of a home domain; and TAG information necessary for decrypting the encrypted license block.

According to still another aspect of the present invention, a method for issuing a license includes the steps of: (a) requesting issue of a license necessary for playing content from a home domain device to a clearing house (or a license distribution server); (b) verifying the license issue request at the clearing house; and (c) creating a license encrypted with at least one of an encryption key of the home domain device and an encryption key of a user, and encrypted again with an encryption key of a home domain, and then transmitting the license to the home domain device.

According to yet another aspect of the present invention, a method for issuing a license at a home domain controller includes the steps of: (a) receiving a license issue request from a home domain device; (b) verifying the license issue request of the home domain device; (c) searching for the location of a corresponding clearing house; (d) requesting issue of a license from the clearing house; and (e) transmitting the license issued from the clearing house to the home domain device.

### [Advantageous Effects]

A license data structure and distribution method according to the present invention enables a license distribution policy to be properly implemented when individual users have multiple content playback devices and/or one domain includes multiple users.

Also, a license data structure and distribution method of the invention may enhance both user convenience and security of digital content.

A license data structure and distribution method of the invention, through various types of services made for using contents to which the Intellectual Property Management and Protection (IPMP) tool is applied, may also prove conducive to a market which can reasonably provide digital contents and satisfy the demands of both copyright holders and consumers.

### DESCRIPTION OF DRAWINGS

FIG. 1 is a diagram of the overall structure of a content protection/management system including a home domain and employing a method for issuing a license according to the invention;

FIG. 2 is a flowchart illustrating a method for issuing a license according to an exemplary embodiment of the invention;

FIG. 3 is a flowchart illustrating a method for issuing a license according to another exemplary embodiment of the invention;

FIG. 4 is a flowchart illustrating a method for creating license data according to an exemplary embodiment of the invention;

FIG. 5 illustrates a license data structure according to an exemplary embodiment of the invention; and

FIG. 6 is a flowchart illustrating a method for issuing a license performed on a home domain controller according to an exemplary embodiment of the invention.

### MODE FOR INVENTION

The invention is performed on a consumer domain system which is called a home domain. A home domain refers to a single home domain controller and groups of users and devices included in the controller. As illustrated in FIG. 1, a home domain controller 50 can make a home domain in which a plurality of users and devices 60-1˜3 are included. The home domain controller 50 which takes charge of domain management may be implemented to perform the role of a multimedia player also (e.g. a set-top box with domain manager), or as a manager only. As such, the home domain controller 50 carries out the major role of defining each home domain and managing each user and/or device 60-1˜3.

A digital content protection/management system linked with the home domain system will now be described. The home domain system of the invention may be used with various types of digital content protection/management system. However, the invention relates to a license in a home domain system, not to a digital content protection/management system. Thus, for clarity and conciseness, operation of the home domain system of the invention will be described with reference to a specific digital content protection/management system.

A broadcasting content protection/management system illustrated in FIG. 1 includes a producer server 10 operated by a content provider; a transmission server 20 for transmitting content input from the producer server 10 to service subscribers; a clearing house 40 for authentication of each subscription region and/or item of content; and a tool server 30 for managing tools for coding /decoding content data.

The clearing house 40 illustrated in FIG. 1 is a sort of license issuing server which issues a license containing rights and conditions for controlling use and issue of content by users, handles billing/payment/settling up according to use of the content, and authenticates users, devices, contents and domains in order to distribute broadcast content. The clearing house 40 may be an integrated authentication system operated by a broadcasting standard authority, etc. for providing an integrated digital broadcasting service, or an authentication system separately operated by each broadcasting station.

As illustrated, the content protection/management system may be used in connection with the home domain system of the invention including a plurality of content playback devices 60-1˜3 and/or users. Here, an authentication data storage module of the clearing house 40 may have information on devices and/or users belonging to each home domain, and an authentication module may perform registration of devices 60-1˜3 and/or users in each home domain.

Hereinafter, exemplary embodiments of the present invention will be fully described with reference to the appended drawings. It will be appreciated that the exemplary embodiments are provided only to facilitate complete understanding of the invention and do not limit the scope of the invention.

### Exemplary Embodiment 1

Procedures for issuing a license to a user in order to play content in a home domain device will be described. There are three plans for issuing a license in the home domain device: acquiring a license from a clearing house through a home domain controller; directly acquiring a license from a clearing house without relay through a home domain controller; and acquiring a license from a home domain controller.

First, implementation of the first and second plans in a system including a clearing house, a home domain controller and a home domain device will be described. Then, selective performance of the first and third plans in the home domain controller will be described.

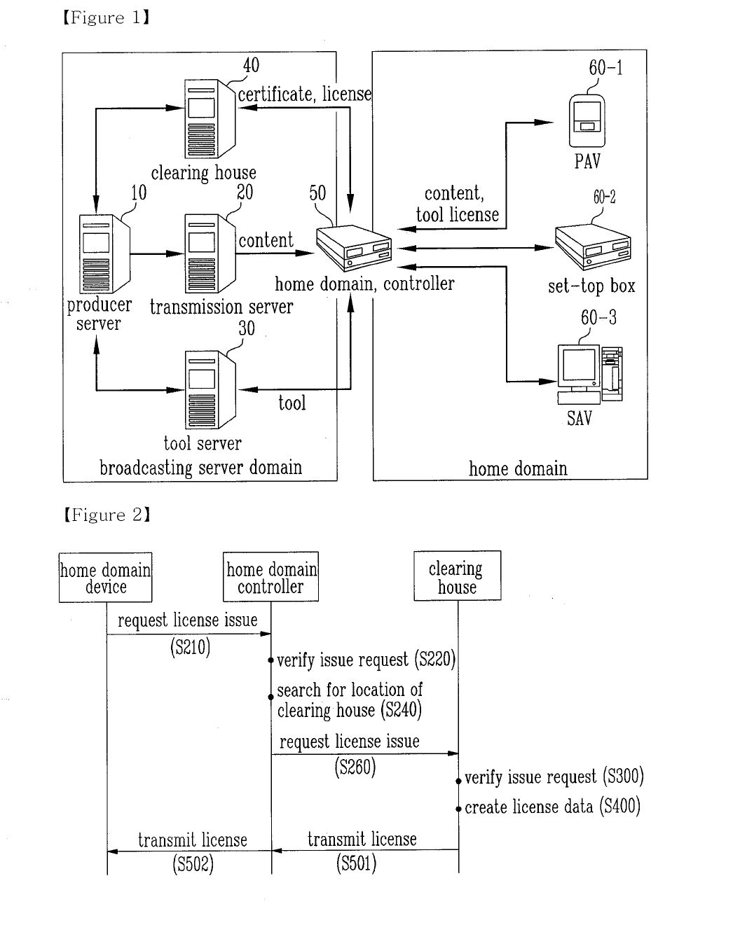

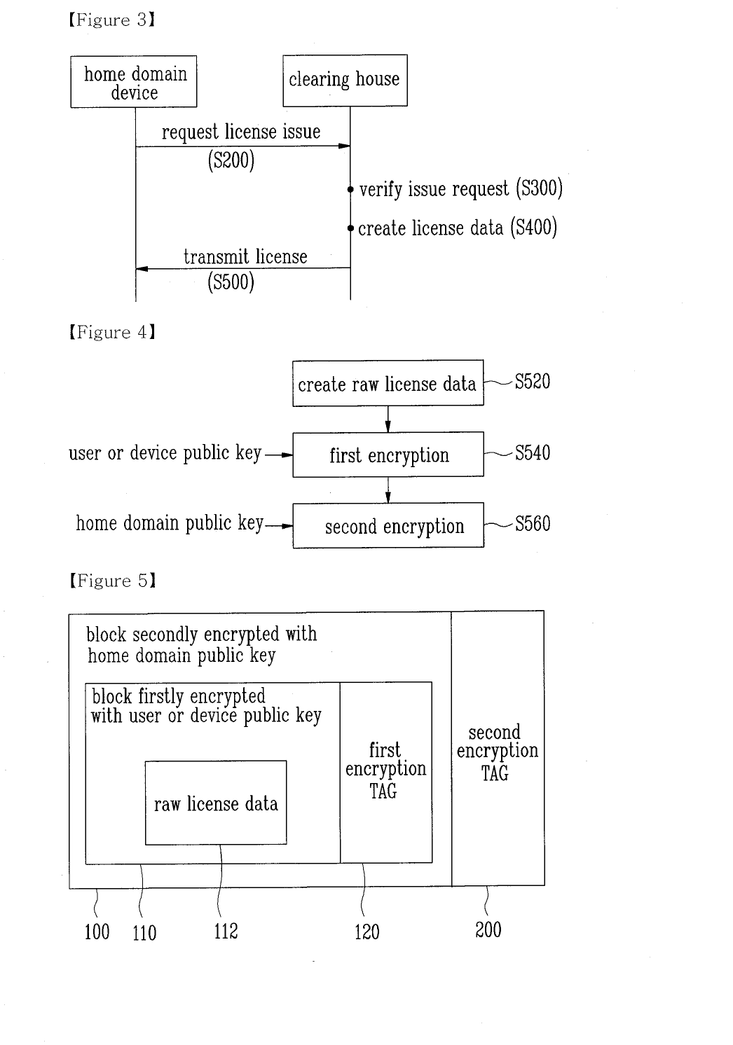

FIG. 2 illustrates steps in a method for issuing a license in a system including a clearing house, a home domain controller and a home domain device, and FIG. 3 illustrates steps in a method for issuing a license in which a home domain device is directly connected to a clearing house.

The method for issuing a license includes the steps of: requesting issue of a license necessary for playing content from a domain device to a clearing house (S200); verifying the license issue request in the clearing house (S300); and issuing a license in response to the issue request (S400) and transmitting the license to the home domain device (S500). Here, in FIG. 2, step S200 may include the steps of: requesting issue of a license from a home domain device to a home domain controller (S210); verifying the license issue request of the home domain device in the home domain controller (S220); searching for the location of a clearing house which can process the license issue request in the home domain device (S240); and requesting issue of a license from the home domain controller to the clearing house (S260). Also, in FIG. 2, step S500 may include the steps of transmitting license data created in a clearing house to a home domain controller (S501), and transmitting the license data from a home domain controller to a home domain device (S502).

To aid in understanding the above steps in the method of issuing a license, a license issuing policy of a license management system to which the exemplary embodiment is applied will be described.

A license issued from the license management system may come in various types, thereby enhancing user convenience when using a home domain system. A license may be limited to a certain duration or number of times of use of corresponding content. Various business models can be implemented using information stored in a clearing house about a home domain, users of the home domain, and a home domain device. For example, with respect to users and device management, application rules like those shown in Table 1 may be applied to the license.

TABLE 1

| Item | Value | Expression |
|---|---|---|
| User | User ID | Available to limited users only |
| | NULL | Permit to all users in a domain |
| Device | Device ID | Available on limited devices only |
| | NULL | Available on all devices in a domain |

The license policy listed in Table I is expressed as the following Table 2 according to combination of a user item and a device item.

TABLE 2

| Value | | |
|---|---|---|
| User Item | Device Item | License Expression |
| NULL | NULL | All users in a domain can use all devices |
| | | in the domain. |
| NULL | Device ID | All users in a domain can use only limited |
| | | devices. |
| User ID | NULL | Limited users in a domain can use all devices. |
| User ID | Device ID | Limited users in a domain can use limited |
| | | devices. |

In this case, the clearing house managing a license grant policy may have a license policy table such as the following Table 3 for each home domain.

TABLE 3

| Content | User Items | Device Items |
|---|---|---|
| A | NULL | NULL |
| B | user 1, user 3, user 4 | NULL |
| C | user 1 | device 2 |
| D | NULL | device 2, device 4 |
| E | NULL | NULL |

In step S200, a user intending to play downloaded content in a home domain device applies for a license using the home domain device. According to the license grant policy in Table 3, the clearing house issuing a license in response to the license issue request requires various information such as a content identifier ID, a home domain ID, a user ID, and a home domain device ID corresponding to the request for issue of a license. In addition, step S200 of transmitting a license issue request to a clearing house may further include the step of transmitting the required additional information. Here, the home domain ID may not be transmitted in step S210, but rather added to the home domain controller in step S260.

Step S220 involves a procedure verifying whether the license issue request received in step S210 is appropriate. Simply, the step may be implemented by the home domain controller recognizing the license issue request. Alternatively, the step may be implemented by checking whether the license issue request is from a user and/or device with permission to use the content according to the license issuing policy, such as Table 3.

Step S240 may recognize a clearing house issuing a license for corresponding content from a content ID contained in the license issue request received in step S220 and verifying the location of the clearing house on this network. When there is one accessible clearing house on a home domain controller, step S240 may simply comprise connecting to the clearing house.

In step S300, it is checked whether the received license issue request is appropriate to the license grant policy as listed in Table 3. For example, a license issue request for content A or E is appropriate on condition of being contained in a corresponding home domain. In the case of content B, a license issue request from user 3 is inappropriate, and in the case of content D, a license issue request from device 2 is inappropriate.

In step S400, when it is verified in step S320 that issuing a license is appropriate, first, raw license data for corresponding content are created. Then, the created raw license data are encrypted according to a key management policy for managing the raw license data.

According to the license key management policy applied to this exemplary embodiment, the raw license data should be encrypted with a public key of a user and/or device registered with a domain. Content B of Table 3 is encrypted with a public key of user 1 or user 2 applying for a license, content D is encrypted with a public key of device 1 or device 3 applying for a license, and content C is double-encrypted with public keys of the permitted user 1 and device 2.

After primarily encrypting the raw data with the public keys of users and devices, data about and the sequence of the encryption process are separately stored in TAG. Then, the first encrypted data is second-encrypted with a public key of a home domain again. Here, it is preferable that TAG containing the information on the first encryption process is second-encrypted together with the first encrypted data.

That is, step S400 may include the steps of: creating raw license data to be issued as illustrated in FIG. 4 (S420); firstly encrypting the raw license data with an encryption key of a user and/or device (S440); and encrypting the data encrypted with the encryption key of a user and/or device with an encryption key of a home domain (S460).

It is preferable that as security keys, that is, encryption and decryption keys, for encrypting a license, asymmetric keys are adopted in the exemplary embodiment for convenience of operation. In the asymmetric key system composed of a pair of an individual key and a public key, each user or device may have an individual key for decryption, and a clearing house issuing a license or a license server in broadcasting system and etc. may have public keys for encryption.

A license data structure generated according to the method of creating license data shown in FIG. 4 is illustrated in FIG. 5. The license data structure includes a second encrypted license block 100 generated by creating a first encrypted license block 110 by firstly encrypting raw license data 112 containing data necessary for playing content with an encryption key of a user or device to whom the data is distributed, and secondly encrypting the first encrypted license block 110 with an encryption key of a home domain where the block is distributed; and TAG information 200 necessary for the decryption of the second encrypted license block 100.

It is apparent that the license data in the present exemplary embodiment has a double capsule structure of raw license data 112 firstly encrypted with a public key of a user or device and secondly encrypted with a public key of a home domain. Additionally, the license data may further include TAG information 120 necessary for decryption of the first encrypted license block 110 and/or for decryption of the second encrypted license block 100. Because the TAG information 120 should be provided before decryption, the TAG information 200 for the second encrypted license block 100 should be in an unencrypted state. However, the TAG information 120 for the first encrypted license block 110 may be in an unencrypted state or may be secondly encrypted in the second encrypted license block 100 together with the first encrypted license block 110. To encrypt data with the public keys of user and device, a method of encrypting raw license data with a combination of the user public key and device public key, or a method of encrypting raw license data with one of two public keys first and then encrypting it again with the other public key, may be used.

The license data created by the above processes is firstly encrypted using an encryption key of a user and/or device and secondly encrypted using a home domain encryption key. Thus, to use the license data, a decryption key of a user and/or device and a decryption key of a home domain are both needed, and there is a need to determine a subject for storing and administrating each decryption key. The home domain decryption key may be stored in a home domain controller, and the device decryption key may be 5 stored in each device, and the user decryption key may be created at each device upon input of a password from a user, or stored in a smart card issued to an individual user.

### Exemplary Embodiment 2

This exemplary embodiment relates to a home domain controller acting as a gateway in a step of requesting issue of a license between a home domain device and a clearing house, or issuing a license to the home domain device directly. That is, when the home domain controller defined in the exemplary embodiment receives the license issue request from the home domain device, it verifies the issue request, checks if the license can be issued by the controller itself or by the clearing house, and then takes appropriate measures.

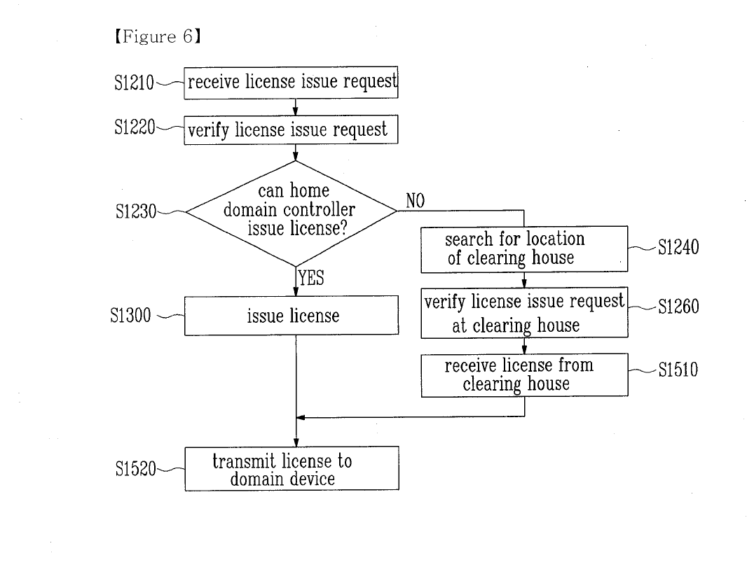

As illustrated in FIG. 6, a method for issuing a license performed at a home domain controller in the exemplary embodiment includes the steps of: receiving a license issue request from a home domain device (S1210); verifying the license issue request of the home domain device (S1220); searching for the location of a corresponding clearing house (S1240); requesting issue of a license to the clearing house (S1260); and transmitting a license issued from the clearing house (S1510) to the home domain device (S1520). After step S1220, the method further includes the steps of: checking whether the requested license is available to be issued at the home domain controller (S1230); and if available, issuing a corresponding license (S1300) and transmitting the license to the home domain device (S1520).

The steps of issuing a license (S1240, S1260) via the clearing house are almost same as in the first exemplary embodiment and thus their description will be omitted. The step of the home domain controller issuing a license (S1300) will now be described.

A home domain device registered with a home domain controller may be granted a license from the home domain controller when the license has been previously issued to the home domain. The license issued for use in the domain is encrypted with a public key of the home domain, but is not encrypted with a public key of a user or the device. The step of issuing a license in the exemplary embodiment (S1300) comprises checking user and device information of the home domain and then determining whether the license can be granted to the user or the device applying for the license.

Reissue of a license is performed by storing license data permitted to be reissued in advance in the home domain controller, re-packaging the stored license data for security, and then issuing a license. Alternatively, license reissue may be performed by receiving a license issuing module which can issue a certain range of licenses from an authorization system (i.e., a clearing house) and issuing a license using the license issuing module. The former method may involve a pre-issued license storage unit in the home domain controller, and the latter may employ the license issuing module and self-issued license lists.

In step S1230, the home domain controller searches for the requested license from license storage unit in the home domain controller. As a result, only the licenses permitted for use in the domain or the licenses permitted for reissuing can be reissued through domain controller.

Thus, when possible, the domain controller itself issues a license (S1300). Here, a license including the pre-issued license data encrypted with a user/device encryption key is issued only to a user/device in the domain conforming to the license policy described in FIG. 2. In addition, a license issued by encrypting data with encryption keys of a device and a user and then adding the encryption TAG as described in FIG. 5 is issued only to specific devices and users. Here, in the event that the device has a domain decryption key, the domain controller issues a re-issue license by again encrypting a license encrypted with a domain public key using a user and/or device public key. But, in the event that the device does not have a domain decryption key, the domain controller removes an encryption capsule using a domain public key and then creates a re-issue license by encrypting with a user and/or device public key. The issued license is transmitted to the device (S1520).

While the invention has been shown and described with reference to certain exemplary embodiments thereof, it will be understood by those skilled in the art that various changes in form and details may be made therein without departing from the spirit and scope of the invention as defined by the appended claims.

1. A method for creating a license, comprising the steps of:
creating raw license data to be issued;
firstly encrypting the raw license data with at least one of a user encryption key and a device encryption key; and
secondly encrypting the firstly encrypted data with an encryption key of a home domain.

2. The method for creating a license according to claim 1, further comprising the step of creating and appending a TAG including information about the first encryption process.

3. The method for creating a license according to claim 1, further comprising the step of creating and appending a TAG including information about the second encryption process.

4. A license data structure comprising:
an encrypted license block created by firstly encrypting raw license data containing data necessary for playing content with at least one of a user encryption key and a device encryption key, and secondly encrypting the data with a encryption key of a home domain where to be distributed; and
TAG information necessary for decrypting the encrypted license block.

5. The license data structure according to claim 4, wherein the encrypted license block is created by encrypting the firstly encrypted raw license data and TAG necessary for its decryption together.

6. A method for issuing a license, comprising the steps of:
(a) requesting issue of a license necessary for playing content from a home domain device to a clearing house;
(b) verifying the license issue request at the clearing house; and
(c) creating a license encrypted with at least one of an encryption key of the home domain device and an encryption key of a user, and an encryption key of a home domain, and then transmitting the license to the home domain device.

7. The method for issuing a license according to claim 6, wherein step (a) comprises the steps of:
requesting issue of a license from a home domain device to a home domain controller;
searching for the location of a corresponding clearing house at the home domain controller; and
requesting issue of a license from the home domain controller to the clearing house.

8. The method for issuing a license according to claim 7, further comprising the step of verifying, at the home domain controller, the license issue request of the home domain device.

9. The method for issuing a license according to claim 6, wherein in step (c), a license is created by performing a method for creating a license, comprising the steps of:
creating raw license data to be issued;
firstly encrypting the raw license data with at least one of a user encryption key and a device encryption key; and
secondly encrypting the firstly encrypted data with an encryption key of a home domain.

10. The method for issuing a license according to claim 6, wherein in step (c), a license is created by performing a method for creating a license, comprising the steps of:
creating raw license data to be issued;
firstly encrypting the raw license data with at least one of a user encryption key and a device encryption key;
creating and appending a TAG including information about the first encryption process; and
secondly encrypting the firstly encrypted data with an encryption key of a home domain.

11. A method for issuing a license at a home domain controller, comprising the steps of:
(a) receiving a license issue request from a home domain device;
(b) verifying the license issue request of the home domain device;
(c) searching for the location of a corresponding clearing house;
(d) requesting issue of a license from the clearing house; and
(e) transmitting the license issued from the clearing house to the home domain device.

12. The method for issuing a license at a home domain controller according to claim 11, after step (b), further comprising the steps of:
(i) checking whether the requested license can be issued by a home domain controller; and
(ii) issuing the requested license by the home domain controller when allowed, and transmitting the license to the home domain device.

13. The method for issuing a license at a home domain controller according to claim 12, wherein in step (ii), the issued license is encrypted with at least one of a user encryption key and a device encryption key.

14. A method for issuing a license at a home domain controller, comprising the steps of:
creating raw license data to be issued;
firstly encrypting the raw license data with at least one of a user encryption key and a device encryption key;
secondly encrypting the firstly encrypted data with an encryption key of a home domain; and
creating and appending a TAG including information about the second encryption process.

15. The method for issuing a license according to claim 6, wherein the license issued in step (c) has a license data structure comprising:
an encrypted license block created by firstly encrypting raw license data containing data necessary for playing content with at least one of a user encryption key and a device encryption key, and secondly encrypting the data with a encryption key of a home domain where to be distributed; and
TAG information necessary for decrypting the encrypted license block.

16. The method for issuing a license according to claim 12, wherein the encrypted license block is created by encrypting the firstly encrypted raw license data and TAG necessary for its decryption together.
